(19) United States
(12) Patent Application Publication
(10) Pub. No.: US 2003/0028665 A1
(43) Pub. Date: Feb. 6, 2003

(54) Method and system of creating and sending electronic tracts

(76) Inventors: Dawn T. McAllister, Greensboro, NC (US); T. Naomie Odoom, Raleigh, NC (US); Carolyn Wilkins Lucas, Durham, NC (US); Monica A. Williams, Union City, GA (US); M. Allen Wilson, Cary, NC (US)

Correspondence Address: COATS & BENNETT, PLLC, P O BOX 5, RALEIGH, NC, 27602, US

(21) Appl. No.: 09/910,559

(22) Filed: Jul. 20, 2001

(51) Int. Cl. G06F 7/00

(52) U.S. Cl. 709/238

(57) ABSTRACT

The present invention is particularly contemplated for using a web-based system to send religious tracts to recipients. The method of creating the tract provides the sender to input subject matter variables regarding the desired content of the religious tract. Previously created phrases matching the subject matter variables are displayed to the sender from which they may select. The phrases that are displayed may be a word, group of words, sentence, paragraph, or complete tract. The sender may further include bible verses, hypertext links to other religious sites on the network, music, artwork, and others. The sender builds the tract using the phrases and other desired information and then sends the tract to the recipient. The tract may be in the form of letters, stories, bible versus, poems, and the like to support and inspire the recipient. The service may be provided by a service provider such as a religious organization such as a local or regional religious organization, by a national or international organization, or both.

### BACKGROUND OF THE INVENTION

Historically, the evangelistic thrust of churches throughout the United States and around the world has been significantly aided by the use of tracts. With the founding of The Religious Tract Society in London in 1799, further aided by the institution of the American Tract Society at Boston, Mass. in 1814, Christians gained a new instrument for promoting the message of the gospel.

A tract is defined as a pamphlet containing “a select portion of divine truth, designed and adapted to make the reader wise unto salvation” (An Address to Christians Recommending the Distribution of Religious Tracts, First Ten Years Of The American Tract Society, Flagg and Gould, 1824, p. 13). A tract contains a “plain, serious, and striking lecture on the salvation of the soul” (An Address to Christians Recommending the Distribution of Religious Tracts, First Ten Years Of The American Tract Society, p. 15). A tract may contain either a message selected and reproduced from another source or an original composition. A tract intends to solicit a response of faith in the reader that results in commitment to a life lived in accordance with the ideals and beliefs of a particular religion.

The American Tract Society established the original standards for a “good tract.” Based on these principles, a good tract should show evidence of the following qualities:

the message conveyed in a tract should contain pure truth as recorded in the religion's sacred book of inspired writings (i.e., The Holy Bible, Koran, etc.);

it should not be contaminated with information that aims to recommend one religious sect or denomination over another. Only that divine truth that seeks to promote the universal cause of a particular religion and generate belief in and commitment to the ideals of the deity of a particular religion should be printed in a tract;

it should be written so that the meaning of the divine truth contained therein is plain. The purpose of a tract is to provide divine instruction;

it should be simple enough to be understood by the massive numbers of readers who have little or no familiarity with the religion's sacred book, the principles of the religion's faith, or the knowledge of the message of salvation which is available to all humanity through belief in the religion's main deity; and

it should be striking in its design so that it allures the attention and engages the mind of the reader. In order to achieve this goal, it is appropriate to blend entertainment with instruction as a method of conveying divine truth. To lessen the likelihood that the tract will be discarded without a perusal, a tract may employ witty expressions, lively representations, engaging narratives, interesting dialogue and other useful and entertaining ideas without compromising purity of doctrine.

Tracts should be designed in such a way that all of the above listed qualities are clearly evident. In addition to the tracts that seek to solicit a response of faith, some tracts should be specifically designed to address the variety of situations and conditions common to the human experience. Therefore, some tracts should penetrate the reader's mind and engage the intellect while others aim for a more powerful effect on an individual's feelings.

Tracts intend to evoke serious reflection, deep conviction, and a sincere response of faith from the readers. Because situations and conditions differ among the young and the aged, the wealthy and the impoverished, the person with no knowledge of God and the person who has been awakened to an awareness of sin, tracts should be developed that will capture the attention, engage the reasoning and address the life situations of persons of various age levels and socio-economic backgrounds. This affords every person the opportunity of receiving the liberating message of the gospel of Jesus Christ (An Address To Christians Recommending The Distribution Of Religious Tracts, First Ten Years Of The American Tract Society, Flagg and Gould, 1824, pp. 18-21).

Printed and distributed widely, paper tracts traditionally have been handed out door-to-door or sent to select individuals or groups through the postal system. This method of distributing tracts is considered by The American Tract Society to be the most inexpensive way of disseminating the knowledge of the Christian religion. This method, as opposed to other means of spreading the gospel, is a less offensive approach. This method makes it possible for a private Christian or religious organization to more extensively distribute the gospel message. This method of distributing religious tracts intends to accompany rather than displace other effective means of disseminating divine truth (An Address To Christians Recommending The Distribution Of Religious Tracts, First Ten Years Of The American Tract Society, Flagg and Gould, 1824, pp. 12-16).

Traditionally the extensive distribution of paper tracts has favorably impacted the Church's ability to make its message more available to the world. Yet it is clear this no longer represents the most effective method for disseminating the message of salvation. In the current age of technology and ingenuity, the written page is no longer one of the world's favored means of transmitting knowledge. As more people turn to the Internet to access information, paper tracts can only discontinue their appeal and decline in effectiveness thereby reducing the reach of what has heretofore been an extraordinary evangelistic tool.

In light of the vast opportunity for evangelism made possible through today's computer technology, various religious organizations have attempted to modernize evangelistic paper tracts by making them available on the Internet for bulk ordering. These tracts, however, remain in their hardcopy form. To date, no organization has succeeded in reinventing the tract in such a way that it will captivate the market.

### BRIEF SUMMARY OF THE INVENTION

The present invention is directed to creating an electronic tract that may be distributed over a network. The software for creating the tract is maintained by a service provider or third party provider. The software allows a sender to reach recipients in a more modern manner.

The software comprises a plurality of pregenerated phrases for creating the tract. The pregenerated phrase may be a word, group of words, sentence, paragraph, or entire letter, story, poem, etc. Each of the phrases is associated or affiliated with one or more subject matter variables. The sender determines the content of the tract that he or she wants to send and enters subject matter variables associated with this content. The variables may include the relationship between the sender and recipient, the state of the human condition which may include overall outlook such as happy, sad, depressed, marital situation such as single, married, separated, divorced, physical condition such as molestation, abortion, and others. Upon receiving the variables, the software displays to the sender at least one pregenerated phrase. The phrase may simply be a single sentencing dealing with the variables, or may be a complete letter, poem, story, or the like. The sender may select one or more phrases to create their tract. Additionally, the sender may include their own personal writings to either augment or be the entirety of the tract. Once complete, the sender delivers the tract to the sender.

### BRIEF DESCRIPTION OF THE DRAWINGS

FIG. 1 is a schematic diagram illustrating an exemplary system such as may be used with the present invention;

FIG. 2 is a schematic diagram illustrating the tract creation software accessible at the service provider and/or third party provider;

FIG. 3 is a flowchart illustrating the logical steps of a sender creating a tract;

FIG. 4 is a flowchart illustrating the logical steps of a recipient receiving a tract;

FIG. 5 illustrates an exemplary display of the interface in which the sender chooses a relationship with the recipient;

FIG. 6 illustrates an exemplary display of the software in which a number of predetermined letters and/or stories are displayed to the sender; and

FIG. 7 illustrates an exemplary display of the software in which the sender may include a scripture verse within the tract.

### DETAILED DESCRIPTION OF THE INVENTION

The present invention is particularly contemplated for use in a web-based system 10 to send religious tracts to recipients. The tracts may be in the form of letters, stories, poems, bible verses, and the like to inspire and support the recipient. The method of creating the tract allows the sender to input information about the recipient. Pregenerated phrases that match the input information are displayed to the sender. The sender may then either select one or more of the pregenerated phrases to construct their tract. Tracts may further include bible verses, hypertext links to other religious sites on the network, music, artwork, and others. The service may be provided by a service provider, which may be a religious organization such as a local or regional church, or by a third party provider such as a national or international organization, or both.

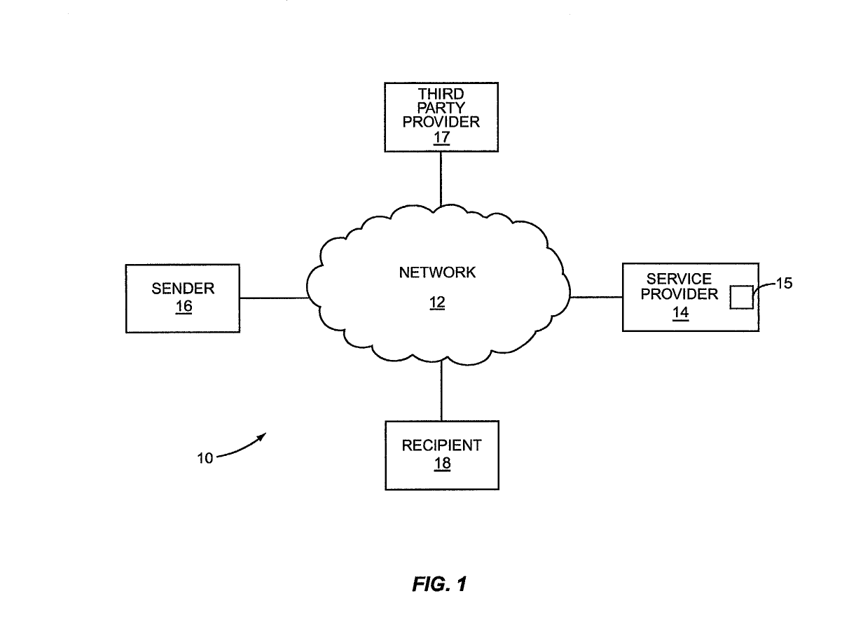

Specifically, FIG. 1 illustrates, in a block diagram format, a system 10 that may be used by the present invention. System 10 comprises a network 12 connected to a number of computers. Specifically, a service provider computer 14 operated by a service provider, such as a local church, ministry, or religious organization, may be connected to the network 12 along with sender computer 16 and recipient computer 18. Senders, for example, may be members of the service provider church and have access to the system as such. Senders may further be non-members who subscribe to the service provider for access to the service. A third party provider computer 17 may further be connected to the network 12.

As used throughout, the term “sender” refers to the actual person who is creating and sending the tract. “Sender computer 16” is the computer interface through which the sender may create and send the tract. A sender may further use a service provider computer 14, a third party provider computer 17, or other computer to send the tract. Likewise, a “service provider” is the religious organization offering the program. “Service provider computer 14” refers to the computer interface where the software 15 may be accessed. This type of terminology is used throughout the specification to differentiate the person or entity from the computer.

As used herein, the term “computer” comprises a number of data processing devices including servers, personal computers, mobile terminals such as cellular phones, lap tops, personal digital assistants, and the like.

Network 12 may comprise a number of related sub-networks, each with its own medium of communication. In an exemplary embodiment, the network 12 comprises the Internet and is comprised of sub-networks such as the Public Standard Telephone Network (PSTN), the Public Land Mobile Network (PLMN), cable networks, satellite networks, and the like. Even within these sub-networks, further sub-sub-networks may exist, for example, Internet Service Providers such as BELLSOUTH.NET, AOL, and the like may have their own proprietary networks through which certain consumers may reach the Internet or network 12. Each sub-network may be comprised of wire based or wireless communication links. For the purposes of the present invention, wire based communication links include optical fiber communication links.

Service provider computer 14 may be a personal computer with a microprocessor therein, or may be a dedicated network server or the like as needed or desired and may include memory and software as is well understood. The software enables the operation of the service provider computer 14 as well as implements certain portions of the present invention as is explained in greater detail below. The memory for service provider computer 14 may be a hard drive, flash memory, EEPROM, CD-ROM, optical CD, floppy disk, DVD-ROM, magnetic tape, or other form of computer memory as is well understood in the field of computers. The software may be written in any appropriate code as needed or desired.

While the service provider computer 14 could be a centralized computer at one physical location, those skilled in the art will appreciate that the service provider computer 14 could use other architectures to accomplish the same functionality. In another embodiment, the service provider computer 14 could be a distributed system with multiple computer systems, each of them comparable to the computer described above, and located at one physical location, linked together through a local area network (LAN). Each of the computer systems performs part of the tasks of the present invention. These tasks may be run in parallel or in series as needed or desired by the system. In yet another embodiment, the service provider computer 14 could be a distributed system with multiple computer systems scattered across a number of physical locations, but linked together through a wide area network (WAN). Each of the computer systems may also perform only one part of the tasks of a centralized host computer system.

It is specifically contemplated that the service provider computer 14 may be connected to the network 12 at all times and therefore should be adapted to have a fail safe and hot-swappable structure. This will allow continued operation even in the event of isolated failures within the system. Additionally, the software may be backed-up regularly, as is well known in the industry, to recover in the event of a catastrophic failure.

In one embodiment (not illustrated), the sender may use the service provider computer 14 for sending tracts. By being a member of the organization, the service provider may offer the sender access through the service provider computer 14. By way of example, the service provider may have service provider computers 14 in a room adjacent to a church such that members who attend services may also use the computer before and after services. One will understand that there are numerous embodiments in which the service provider may offer access to the service provider computer 14, and hence the network 12 for sending tracts.

A third party provider computer 17 may further be connected to the network 12 and have access to the information organized and maintained at the service provider computer 14. In one embodiment, the third party provider is a headquarters for a religious community, and the service providers are the individual community churches affiliated therewith. By way of example, third party provider may be headquartered in Raleigh, N.C., and have several smaller churches throughout eastern North Carolina. The third party provider computer 17 may have access to the network 12 to maintain updated information on members at each of the smaller churches. Additionally, the smaller churches and the members may have access to information maintained at the third party provider computer 17. The third party provider computer 17 may be different from, or substantially identical to the service provider computer 14 described above.

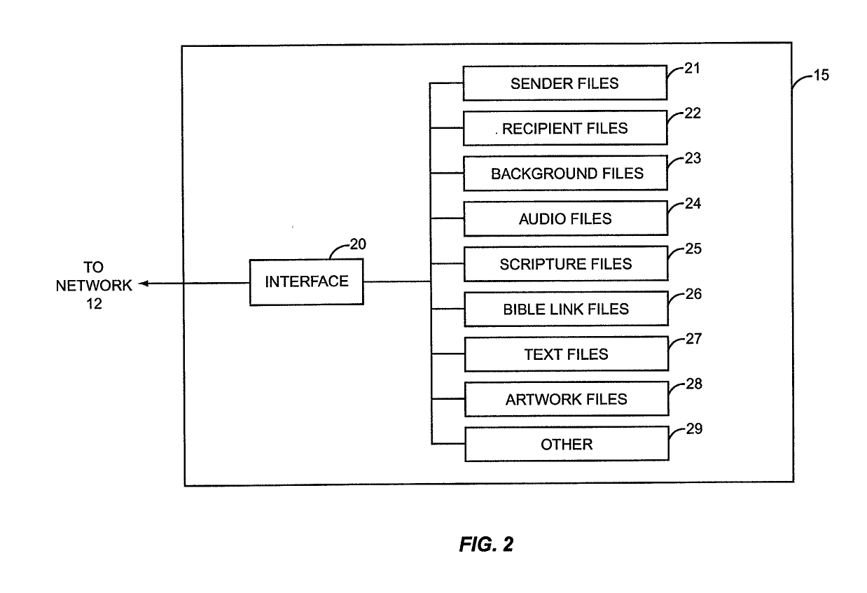

FIG. 2 illustrates the structure of one embodiment of the service provider computer 14 having the tract creation software 15. The software 15 may additionally be provided at the third party provider computer 17. An interface 20 allows for accessing and manipulating the files associated with the software 15. Additionally, a security gate may be included at the interface 20 to prevent unauthorized persons from gaining access to the service provider computer 14. Security gate may require a password or the like which is only given to members and/or guests. Other firewalls or the like may also be used as needed or desired.

Upon gaining access to the service provider computer 14, the sender begins to create their tract for delivery to a recipient. The tract may take many forms, such as a letter, poem, or story and depends upon the desires of the sender.

In addition to the interface 20, the software 15 may comprise additional components. Sender file 21 may comprise information relating to the senders who use the tract creating services of the present invention. Specifically, the sender file may include personal or profile information about the sender. Exemplary information may include a name, address, telephone number, email address, or the like. Further, the sender file 21 may contain information about the sender that is useful when creating the tract. For example, the sender files 21 may include previously created tracts that may be accessed and altered for sending to a new recipient, the addresses of recipients to whom the sender has previously sent tracts, favorite scripture verses, artwork, and the like that the sender may desire to include in a future tract.

Recipient files 22 may include recipients email and home addresses. Personal information such as birthdays, marital status, and the dates and types of previous tracts that have been sent may also be stored within the file 22. Other personal information may be included if needed or desired.

Background files 23 may include graphic images that are used as background stationary for any tract created. The files may include humorous, cartoons, photographs, landscapes, or other images on which the tract is superimposed. In one embodiment, a sender may upload a file and use it as a background much like wallpaper on a computer monitor.

Audio files 24 include audio clips and songs that can be included with the tracts. These files are attached to the tracts and are accessed by the recipient when the tract is open. Files may be short clips from various songs, or may include the entire song. The files may further include different versions of songs, such as an instrumental or live versions. For example, “Amazing Grace”, “Rock of Ages”, “Jesus Loves Me” may be used. A variety of different songs may be included within the audio files 24 for the sender to tailor the music to the tone of the tract. A more up-beat and lively song may be appropriate for a younger child, while an up-lifting and inspirational song may be appropriate for a friend who is having a dilemma in their life. Additionally, interface 20 may allow for the sender to create their own music and include it within the tract. Software for recording and saving music is well-known and is not discussed in detail herein.

Scripture files 25 include scripture verses that are included within the tracts. The scripture files 25 may have a variety of lengths from a single sentence, to an entire passage depending upon the context and desires of the sender. A list of popular and relevant verses may be highlighted for the user to choose. Alternatively, the user may type in their own scripture verse as they desire.

Bible link files 26 include links to other network sites for accessing scripture verses. Examples of links include www.audio-bible.com that allows the sender to research a particular verse that they desire to include in their tract. Additionally, the bible link site may be included in the tract to allow the recipient to access the bible.

Text files 27 may contain a plurality of pregenerated phrases from which tracts may be assembled. The term “phrases” represents the format of the pregenerated information for creating the tract. Phrases may have a variety of lengths ranging from a word, groups of words, sentences, paragraphs, quotes, stories, poems, letters, etc. Each of the phrases relate to particular subject matter variables that are presented to the sender when constructing a tract as will be described in greater detail below. For example, some phrases may be salutations based on a relationship provided by the sender like “Dear Mom.” Others may be phrases or paragraphs relating to an event that caused the sender to feel it was appropriate to send the tract. In one embodiment, the phrases may be spliced together to form coherent sentences and create a letter that is composed of phrases within the text file 27 and customized by the sender.

Artwork files 28 include pictures, photographs, etc. that the sender may include in the tract. The art may form a background over which the text of the tract appears, or may be a prominent part of the tract and help to convey the message of the sender. Additionally, sender may be able to create their own art and import it into the tract. Numerous art creation software packages are available for the sender to create art and include it within their tract.

Additional elements may be included within the software package and are labeled under space 29. An individual church may tailor specific items that members desire to include in their tract. This may include drawings or symbols that identify the church such as logo 90, information about religious persons or saints, religious passages including steps to salvation, sinner's prayer, information about the religious organization, and the like. Each church may customize the software by including specific items within these files such that information is included with the tract when sent to the recipient.

Interface 20 allows the various files and databases to be manipulated to create a tract by the sender. Specifically, the interface 20 allows the sender to register therewith and provide inputs relating to subject matter of phrases in the text files 27 and from these inputs may present one or more of the phrases to the sender for selection for inclusion in a tract. Exemplary subject matter phrases include relationships (e.g., mother, father, sister, friends, family, etc.), state of human condition (e.g., grieving, illness, happy, etc.), marital status (e.g., single, married, widowed, etc.), social topics (e.g., abortion, divorce, molestation, etc.), age range, and the like. The pregenerated phrases are displayed to the user who then may select the phrase or phrases to construct their tract, or the phrase may already be a complete tract that is ready to be sent to the recipient. In either case, the sender may further edit the phrase or phrases through the use of the interface 20 such that the tract is personalized to the needs of the recipient and communicates the thoughts of the sender. After the sender has completed the tract creation process, the interface 20 may include an email mechanism by which the service provider computer 14 sends the tract to the recipient through the network 12.

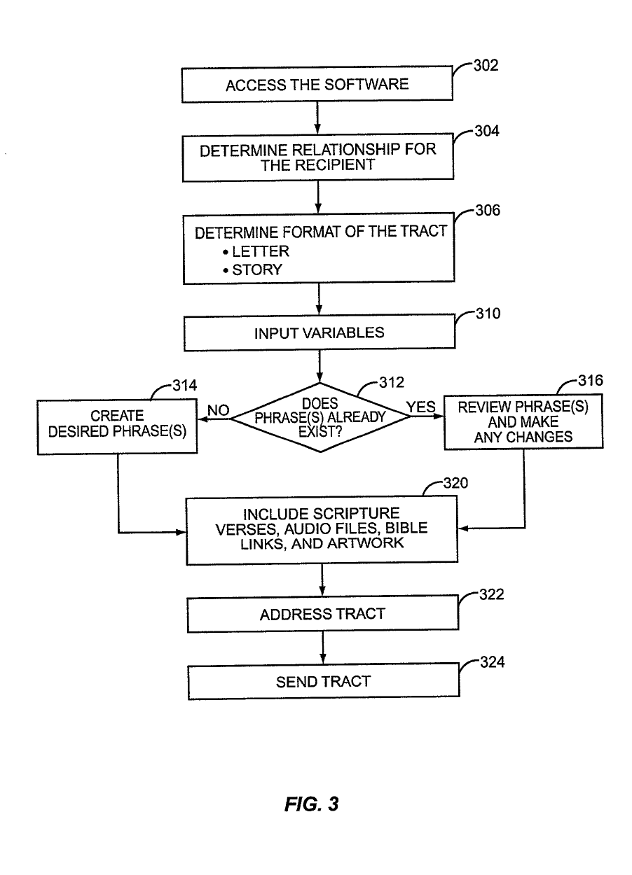

FIG. 3 illustrates an exemplary embodiment of a logical progression of a sender creating a tract. Initially, sender accesses the software 15 (step 302) through the service provider computer 14, the third party provider computer 17, or other. As previously stated, this may be a connection through the network 12, or may be achieved by logging directly into the software 15 at the service provider or third party provider computers 14, 17. Upon accessing the software 15 and working through the interface 20, the sender provides one or more subject matter inputs regarding the content of the tract they he or she wishes to create. The software may display possible choices for the user to select their subject matter, or may allow the sender to enter the subject matter and will search the text files 27 for related information.

To increase the processing speed, software 15 may be structured to receive multiple subject matter inputs prior to retrieving the information from the files. The multiple inputs allow the software to narrow the associated pregenerated phrases and only display to the sender the specific phrases meeting their requirements. Without this feature, the files may be excessively large causing slowed response time. Similarly, as the sender progresses through the tract creation and narrows the scope of their desired tract, the amount of relevant data continually decreases thus allowing for faster and faster processing speeds.

In one embodiment, the first subject matter variable input is the relationship of the recipient to the sender (step 304). This relationship may be a family relationship such as mother, son, wife, aunt, or other such as friend, acquaintance, etc. Additionally, sender inputs the relationship that he or she has with the recipient. This may include a relationship like a son, grandmother, best friend, teacher, staff, sorority/fraternity.

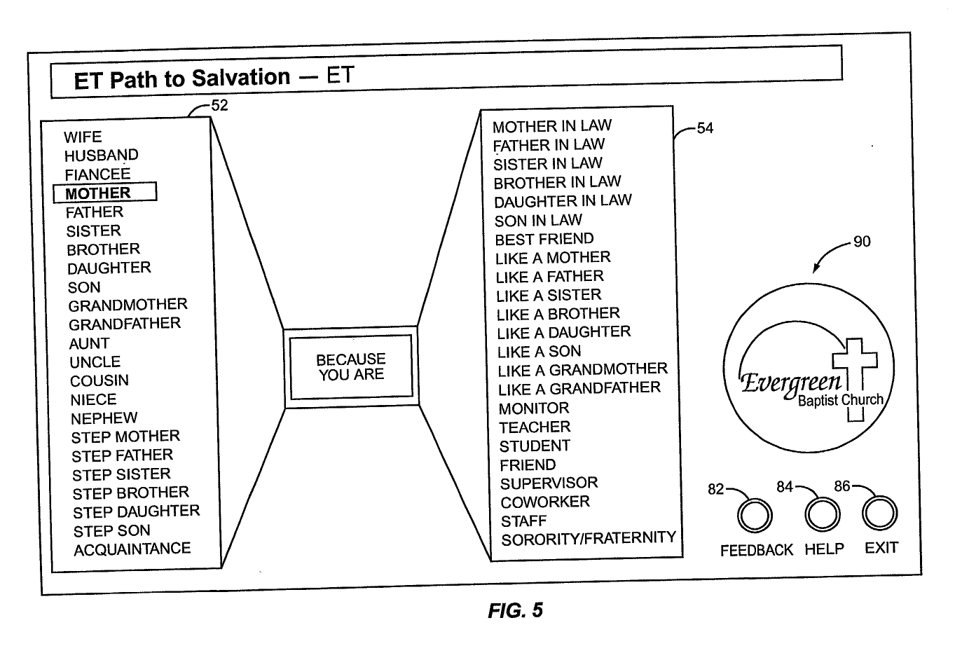

FIG. 5 illustrates one embodiment of a first input screen that the sender encounters upon accessing the software 15. The columns 52 and 54 include the relationship or relational bond between the sender and the recipient(s). Numerous combinations are available as needed by the sender. Additionally, a prompt box (not illustrated) may allow the user to input a selection that is not otherwise listed. Throughout using the software 15, selections may be chosen via key entry, a mouse click, touch screen input, voice activation, or the like. Additionally, the sender may address the tract to one or more recipients as they deem necessary.

Returning to the logic of FIG. 3, the sender may determine the format of the tract (step 306). Traditionally, tracts are in the format of a story, letter, poem, however, various other formats may be available depending upon the extent of the software 15 and the desires of the sender. The sender may further select the style or tone of the tract such as elegant, humorous, international, sports, casual, nature, people, cool designs, abstract, and the like.

The sender then may input additional subject matter variables regarding the recipient and the desired content of the tract (step 310). Variables may include the state of the human condition including abortion, divorce, molestation, birth of a child, married, single, abused, battered, molested, prisoner, homosexual, etc.; age ranges of the recipient, etc. Other variables may further be included in the selection process to further refine and tailor the format desired.

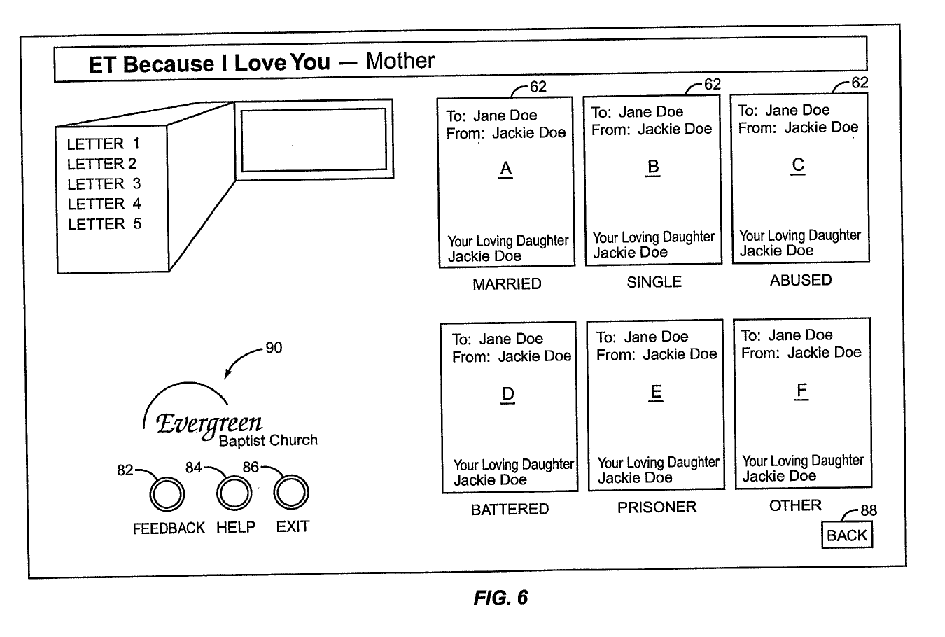

Once the variables are input, text file 27 is accessed and the pregenerated phrases that are closest to those meeting the sender's variables are displayed. These may include words, statements, phrases, paragraphs, or complete letters, stories, or poems. The example illustrated in FIG. 6 shows the user having selected a letter format and the various phrases 62 that match the subject matter input. In this example, there are six pregenerated letters that meet the sender's subject matter and indicated by letters A, B, C, D, E, and F. Each of the letters A, B, C, D, E, and F will be different allowing the sender to chose one that best conveys their message. In other embodiment, the matching phrases may not be an entire letter but rather a list of words,statements, paragraphs, that the sender may use to create their tract.

Returning to FIG. 3, the sender reviews the displayed phrases and determines whether any meet his or her needs (step 312). If one or more of the phrases is acceptable, sender selects the phrase or phrases (step 316). The selected phrase or phrases may further be edited such that the sender can change any wording or include additional information that is not otherwise included. If a phrase does not already exist, the sender may create their own (step 314). This may use default text from the text file 27, the sender's own creation, or a combination of both.

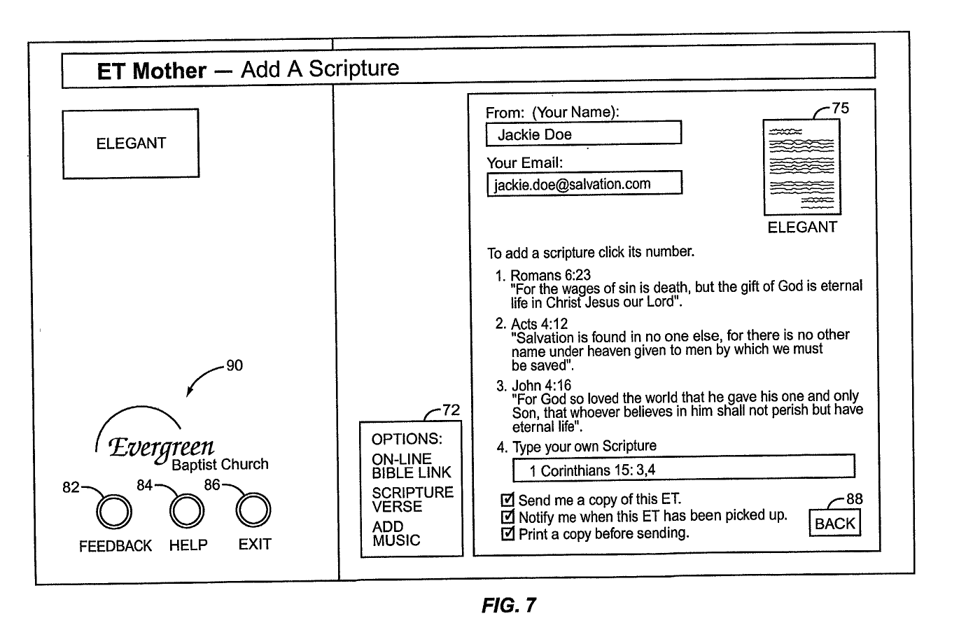

In either event, once acceptable phrases are selected or created and the tract is complete, sender may then include scripture verses, audio files, bible links, artwork, and others from the corresponding files. More than one of each of these items may be included within the tract depending upon the desire of the sender. FIG. 7 illustrates one embodiment illustrating the input screen displayed to the sender. Option keys 72 are located on the screen for the sender to select to include the applicable files to the tract. FIG. 7 illustrates an example of the sender including scripture verses. These scripture verses may coincide with the variables selected for the format and listed as a function of the software. The sender may include one or more of these verses, or may include their own selection by inputting the selection within the appropriate input field. The tract is then addressed and sent to the recipient (steps 322 and 324). The sender may additionally chose whether they would like to receive a copy of the tract, receive notification when the tract is accessed by the recipient, or print a hard copy of the tract. When the tract is sent, service provider 14 or third party provider 17 may further include additional information within the tract such as prayers, steps to salvation, etc. selected from the other file 29.

As illustrated in FIGS. 5, 6, and 7, one or more of the input screens include directional assistance for the sender. A feedback button 82 allows the sender to send a message to either or both the service provider computer 14 and third party provider computer 17. A help button 84 allows the user to receive instructions regarding how to properly complete a tract. An exit button 86 allows the sender to exit the software. Additionally, back button 88 allows the sender to retract the creation steps to change variables or selections that have already been entered into the software 15.

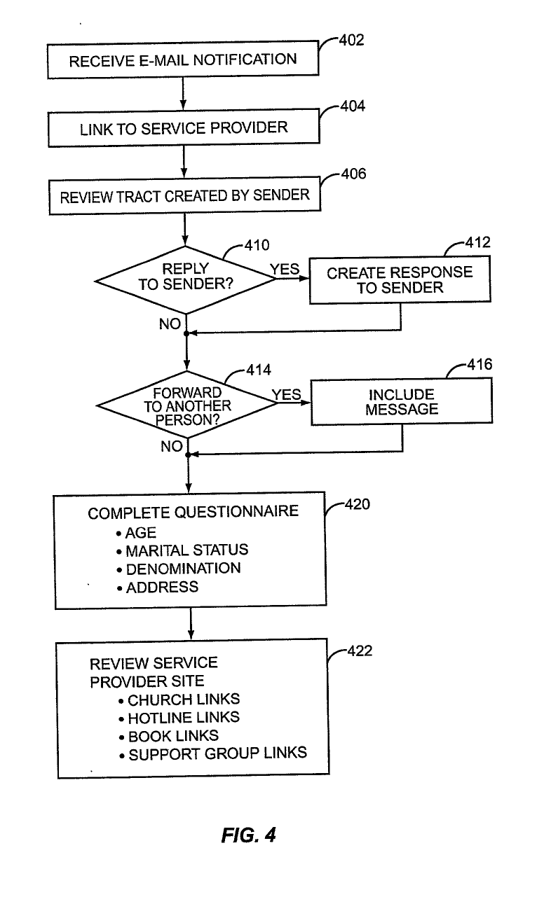

FIG. 4 illustrates one embodiment of the steps of a recipient receiving an electronic tract. Initially, the recipient receives a notification that a tract has been sent to them (step 402). The notification may include a hyperlink to the software at the service provider computer 14 or the third party provider computer 17 (step 404). The notification may further include a password or other type of identification that is necessary to access their tract. Once at the host web site, the recipient may input the identification to access their tract (step 406). Upon reviewing the tract, the recipient may desire to reply to the sender (step 410) at which time they may send a message thanking them or otherwise acknowledging their receipt (step 412). The recipient may also desire to forward the tract to another person (step 414) and may further include their own personalized message (step 416).

After reviewing the tract, the recipient may be asked to answer a questionnaire (step 420). The questionnaire may include a welcoming statement thanking the recipient for accepting the tract and introducing them to the religious organization. Questions posed may include the recipient's age, marital status, denomination, membership size of current affiliated religious organization, and location. The information from the questionnaire is collected at the service provider computer 14 and/or third party provider computer 17 for their records, and, for example, may be stored in recipient file 22.

The recipient may further peruse the website of the service provider computer 14 or third party provider computer 17 to discover more information about the various religious organizations which are available to them (step 422). These sites may contain links to specific religious organizations or list addresses for religious organizations in the recipient's geographic area. Hot line links may provide support for persons with emotional problems, book links may give insight and guidance regarding books that may be of interest, and support group links may provide access to other similar persons.

As illustrated in FIG. 7, a sample format 75 may be displayed at each screen as the sender is creating the tract. The sample format 75 illustrates the tract that has been created by the sender. The sender may review the sample format 75 and make any changes as they deem necessary.

FIGS. 5, 6, and 7 include a service provider insignia 90. A service provider who purchases the software 15 from a third party provider may personalize the display screens such that the users will associate it with the particular service provider. Insignias may be stored in the other file 29 and personalized as needed by the service provider. The tract may further include a list of frequently asked questions regarding the religious organization. This information may also be stored in the other file 29 and included within each tract.

The web-based tracts may be converted into a data storage format (i.e., cd-roms, mini cd-roms, etc.) to be sold and/or distributed individually or in bulk to churches, ministries, organizations, and the like. In another embodiment, the tracts may also be converted into a hard copy tract and distributed accordingly. Additionally, the tracts may be converted into MP3, flash, video files, and the like for distribution via the Internet and/or data storage format.

The present invention may, of course, be carried out in other specific ways than those herein set forth without departing from the scope and the essential characteristics of the invention. Tracts have been described in the context of stories and letters. However, the tracts may take other forms as desired by the sender. The present embodiments are therefore to be construed in all aspects as illustrative and not restrictive and all changes coming within the meaning and equivalency range of the appended claims are intended to be embraced therein.

What is claimed is:

1. A method of creating a religious tract, comprising:
providing a plurality of pregenerated phrases from which a religious tract can be created;
affiliating each of said pregenerated phrases according to at least one subject matter variable;
receiving input from a sender comprising at least one of said subject matter variables;
displaying to the sender the affiliated pregenerated phrases associated with the subject matter variables; and
creating the religious tract using the pregenerated phrases selected by the sender.

2. The method of claim 1, further comprising receiving a selection from the sender selecting one of said displayed pregenerated phrases for inclusion within the religious tract.

3. The method of claim 1, wherein the subject matter variables are selected from the group consisting essentially of relationships, state of human condition, age range, and social topics.

4. The method of claim 1, further comprising the step of adding an audio file to the religious tract.

5. The method of claim 1, further comprising the step of adding a hypertext link to the religious tract.

6. The method of claim 1, further comprising the step of adding a scripture verse to the religious tract.

7. A computer readable medium comprising software, said software comprising:
a text file comprising a plurality of phrases from which a religious tract may be created; and
an interface, said interface adapted to
receive inputs from a sender about subject matter variables from which selected ones of said phrases are accessed in said text file;
display one or more religious tracts to said sender; and
email an assembled religious tract to a recipient through a network.

8. The computer readable medium of claim 7, further comprising a sender file for maintaining information regarding the sender.

9. The computer readable medium of claim 7, further comprising a recipient file for maintaining information regarding the recipient.

10. The computer readable medium of claim 7, further comprising an audio file for attaching an audio file to the religious tract.

11. The computer readable medium of claim 7, further comprising a scripture file for including a scripture passage within the religious tract.

12. The computer readable medium of claim 7, further comprising attaching a bible hypertext link to the religious tract.

13. The computer readable medium of claim 7, further comprising including artwork within the religious tract.

14. A method of promoting religions, comprising:
hosting a web site with pregenerated religious tracts available thereon;
receiving inputs from a sender regarding subject matter that the sender desires to convey to a recipient, one of said inputs comprising a relationship between the sender and a recipient;
presenting one or more of said pregenerated religious tracts to said sender based on the inputs;
receiving a request choosing one of the pregenerated religious tracts from the sender; and
sending the selected pregenerated religious tract to the recipient indicated by the sender.

15. The method of claim 14, wherein hosting a web site with pregenerated religious tracts comprises hosting a web site with a sender accessible interface.

16. The method of claim 15, wherein hosting a web site with the pregenerated religious tracts comprises hosting a web site with a plurality of data files accessible through said interface.

17. The method of claim 16, further comprising allowing a sender to customize the selected pregenerated religious tract by accessing said data files and inserting data contained with said data files into the religious tract.

18. The method of claim 14, wherein the step of hosting the web site with the pregenerated religious tracts comprises hosting the web site at a local service provider.

19. The method of claim 14, wherein the step of sending the selected pregenerated religious tract to the recipient comprises sending the recipient a message indicating the existence of the religious tract and allowing the recipient to access said sent selected pregenerated religious tract on said web site.

20. The method of claim 19, further comprising soliciting information from said recipient upon said recipient accessing said selected pregenerated religious tract on said web site.

21. A method of generating interest in religion, comprising:
hosting a web site on a service provider computer, said service provider computer associated with a local religious organization;
providing an interface through said web site;
allowing a sender to access said interface;
receiving input from said sender;
generating a pregenerated religious tract for said sender in response to said input;
allowing said sender to edit said pregenerated religious tract; and
sending said religious tract to a recipient.

22. A method of creating an electronic religious tract comprising the steps of:
saving a plurality of different pregenerated religious phrases each classified according to at least one subject matter variable;
receiving input from a sender comprising one of the subject matter variables;
displaying to the sender a plurality of the pregenerated religious phrases classified according to the subject matter variable;
receiving a request from the sender choosing one of the pregenerated religious phrases; and
constructing the religious tract to include the chosen pregenerated religious phrase.

23. A method of creating a database, comprising:
offering an opportunity for senders to send religious tracts to one or more recipients;
sending the religious tracts to the one or more recipients;
after receipt by the recipients, querying the recipients for information; and
storing the information received from the recipients in the database.
